(19) United States
(12) Patent Application Publication
(10) Pub. No.: US 2015/0026007 A1
(43) Pub. Date: Jan. 22, 2015

(54) SMART HOME ENVIRONMENT FOR SHOPPING

(71) Applicant: International Business Machines Corporation, Armonk, NY (US)

(72) Inventors: Amit M. Mangalvedkar, Bangalore (IN); Sivananthan Perumal, Bangalore (IN); Dhandapani Shanmugam, Bangalore (IN)

(73) Assignee: International Business Machines Corporation, Armonk, NY (US)

(21) Appl. No.: 14/108,665

(22) Filed: Dec. 17, 2013

Related U.S. Application Data
(63) Continuation of application No. 13/943,075, filed on Jul. 16, 2013.

(51) Int. Cl. G06Q 30/06

(52) U.S. Cl. CPC G06Q 30/0633
USPC 705/26.8

(57) ABSTRACT

A smart home environment shopping system. One or more inventory needs lists are received from one or more respective smart appliances. Sources for available inventory items on the received inventory needs lists are identified, based on pre-defined rules. In another aspect of the invention, the available items are displayed to a user, and one or more inputs indicating inventory items to purchase are received. In a further aspect, associated metadata for one or more of the available items is displayed, the metadata including one or more of: price, discounts, quality, brand, flavor, user reviews, and advertisements. In a further aspect, one or more optimal travel routes connecting all identified sources of the available inventory items on the received inventory needs lists are determined.

### CROSS-REFERENCE TO RELATED APPLICATIONS

This application is a continuation of U.S. patent application Ser. No. 13/943,075, filed Jul. 16, 2013, which is hereby incorporated by reference in its entirety.

### FIELD OF THE INVENTION

The present disclosure relates to needs based shopping carts at appliances in a smart home environment, or thereby creating a smart home environment, and more particularly, to synchronization of home shopping carts or needs with home appliances.

### BACKGROUND

Home automation has been gaining in importance in recent times and generally provides interconnection and control capabilities for home appliances, especially in a smart home environment or for creating a smart home environment. Home automation generally includes automation of the home, housework, or household activity, which may include centralized control of lighting, HVAC (heating, ventilation and air conditioning), appliances, security locks of gates and doors and other systems, to provide improved convenience, comfort, energy efficiency, security and the likes. Importantly, home automation for the elderly and disabled can provide increased quality of life for persons who might otherwise require caregivers or institutional care. The popularity of home automation has been increasing in recent years because of higher affordability and simplicity through smartphone, tablet and other forms of connectivity. For example, air conditioners, heaters, lights, refrigerators and other appliances in a home environment may be controlled remotely, for example by turning on or turning off these devices. In some cases, control on devices may be performed remotely by a user using a computer or a mobile device or any portable electronic device, for example a cellular/mobile telephone.

### BRIEF SUMMARY

Embodiments of the present invention disclose a method, computer program product, and system for smart home environment shopping system. One or more inventory needs lists are received from one or more respective smart appliances. Sources for available inventory items on the received inventory needs lists are identified, based on pre-defined rules. In another aspect of the invention, the available items are displayed to a user, and one or more inputs indicating inventory items to purchase are received. In a further aspect, associated metadata for one or more of the available items is displayed, the metadata including one or more of: price, discounts, quality, brand, flavor, user reviews, and advertisements. In a further aspect, one or more optimal travel routes connecting all identified sources of the available inventory items on the received inventory needs lists are determined.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a cloud computing node according to an illustrative embodiment;

FIG. 2 depicts a cloud computing environment according to an illustrative embodiment;

FIG. 3 depicts abstraction model layers according to an illustrative embodiment;

FIG. 4 depicts an illustrative embodiment of a system for smart home shopping;

FIG. 5 depicts a flowchart illustrating operation of a method in accordance with an illustrative embodiment; and

FIG. 6 depicts a typical smart appliance shopping cart, as implemented in XML code.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art should understand the concepts of the invention and should recognize applications of these concepts not particularly addressed herein. It should be understood that these concepts and applications fall within the scope of the disclosure and the accompanying claims.

The subject matter described herein provides for a smart home environment for shopping based on a user's needs. In an exemplary embodiment, a distribution device within a home network (e.g., a set-top-box (STB), or other device) implements a publish/subscribe protocol for inventory management that manages inventory of smart home appliances within a home environment which are typically based on the needs of the user. The device further subscribes with one or more servers in a cloud environment or the internet in general to receive content, for example advertisements, based upon current needs of the inventory management devices, and receives and distributes (i.e., pushes) content to the smart home appliances and the interfaced portable electronic device of the user. The smart home appliances process a user needs list and add items to create shopping carts within the home appliances using a rule engine that compares, for example, the discounts offered with current inventory. A device, such as a mobile phone or other handheld device, consolidates the shopping carts of the different smart home appliances into a shopping cart based on the needs list. The shopping cart may be configured with a shopping travel route which is determined based upon purchase location information associated with shopping cart items based on data that is available on the internet or social media or cloud and guides the customer to choose the best offer and place an order for the item on the needs list and then have the item ordered and delivered, from different sources.

Present technology provides for intelligent interconnection of intelligent or smart home appliances with live or near-live content (e.g., advertisements, discounts, promotions, new products, user feedback and reviews, and various other parameters). For purposes of the present description, intelligent or smart home appliances may be considered to be any appliance in a home environment or area of a home that is configured to programmatically create and process inventory for the respective area and/or to document items that are to be purchased specifically based on a user need. For example, intelligent or smart home appliances may include, among other appliances, and not limited to, a refrigerator, a wardrobe, a grocery shelf/pantry, a bathroom, a clothes wash room, a home office, etc. These intelligent or smart home appliances will be referred to herein in the alternative, or generally as “smart home appliances” or simply “home appliances,” as convenient for purposes of the particular portion of the description below.

Individual shopping carts are created and managed by the respective smart home appliances. These individual shopping carts are referred to herein as “shopping carts.” A consumer's computer at home or mobile device or the computer interfaced with the mobile device may automatically synchronize with the shopping carts of the respective smart home appliances to configure a consolidated shopping cart. As such, the home appliances manage shopping carts that are synchronized and consolidated into a single shopping cart for use by consumers during shopping events and outings in one embodiment.

As content is broadcasted using various streams, such as an audio and/or video stream, such content may be received by, for example, a television associated with a smart home environment, and the content may be distributed and stored within the shopping cart(s) of those respective home appliances if a specific user need is identified. The shopping carts may be configured to respond to content for particular items or types of items for which the respective home appliances are configured to manage an inventory. The addition of items to the shopping carts may be performed by a set of pre-defined rules in the smart home appliances that is configured based upon several considerations, such as product availability, the discount offered, comparison of discounts among multiple vendors, proximity/location of the vendor, user feedback and other factors as appropriate for a given implementation. By leveraging the smart home environment, an intelligent consolidated shopping cart is created and provided in a mobile device by synchronizing the shopping carts from the respective home appliances. The mobile device in one embodiment may be configured to poll and consolidate the commodity data from the respective home appliances. The consumer may then utilize the mobile device during a shopping trip to collect the items or order the items online to be purchased based upon discounts, feedback, manufacturer and various other parameters.

As such, intelligent and interconnected home appliances are configured to maintain up-to-date/current information about commodities and restocking goals, i.e., a user need for an item, and should be also configured to recognize purchase opportunities and reorder based upon available promotions and/or discounts and/or other parameters such as user feedback on the products. etc. Such an environment typically provides a convenient shopping experience for customers and is advantageous in saving time for the customer/user.

The home appliances may be configured to automatically/programmatically determine current inventory. For example, particular slots in a refrigerator may be utilized for milk, cheese, eggs, sandwich spread, and other inventory items. These slots may be configured in such a way to determine the current amount of inventory on hand. When the inventory decreases to a configured reorder level/threshold, a user need arises and the inventory item may be triggered by the home appliance for reordering. Alternatively, if the user is going out on vacation, then the appliance may trigger an alert to the user and may not create a user needs list until the user is back from vacation. The words, customer and user, in this application, are used interchangeably and have the same meaning. Additionally, variances may be configured for the reorder levels/thresholds to flag creating a list for reordering where an inventory item is within a configured percentage or amount of a configured reorder level/threshold and advertising content that is received indicates that reordering during a particular time frame may save money for repurchase of the respective inventory item(s).

Additionally, in one embodiment the home appliances may be configured to automatically/programmatically process shelf life dates for products (e.g., milk, cheese, eggs, etc.) to allow reordering if the shelf life of the particular product has expired, or is about to expire, and also alert the user regarding this. This shelf life information may be included in the appliance's shopping cart, and, during synchronization, consolidated to, for example, the mobile device's shopping cart.

Inventory item (reorder item) purchase/availability location information may be processed in association with reordering at the shopping carts. This purchase/availability location information may be processed as part of the consolidation processing via the consolidated shopping cart to determine optimal travel distances and travel routes for the consumer to acquire the respective inventory items to be purchased. For example, a user's mobile device that is hosting the shopping cart may be configured to determine optimal travel routes for shopping trips using the purchase/availability location information of the set of inventory items to be acquired during a particular shopping trip. Determination of optimal travel routes may be performed using map information in association with address information or global positioning satellite (GPS) information, or otherwise as appropriate for a given implementation. The optimal travel route may be based on the shortest distance, the fastest route, and/or other factors defined by the user. As such, the consumer's travel time, travel distance, shopping time, and shopping costs may also be improved to a large extent. In one embodiment, the mobile device may directly order the items to be delivered to the user from locations where the product is available based on the various parameters that have been identified to determine the best source of availability of the product.

It should be noted that concept of this subject matter resulted from recognition of certain limitations associated with conventional home shopping. First, it was observed that people generally utilize manual paper shopping lists that they generate between shopping trips, and that they may keep notes on appliances with a manual listing of items needed (e.g., milk for a refrigerator, laundry detergent for a washing machine, etc.). Additionally, it was observed that advertisers are limited in their attempts to communicate with potential customers because they are often not available or not watching television, for example, when advertisements are transmitted. Further, it was observed that even where consumers are exposed to advertisements, the consumers or the appliance connected to receive such information may not update their shopping lists properly. It was also observed that, even where consumers collect all of the notes from the respective appliances, they may not consolidate the notes into a shopping list based upon where to shop for the best discounts on the items they intend to purchase. The present subject matter improves consumer shopping and costs, and improves effectiveness, by providing for intelligent and interconnected home appliances that receive a needs list of a user and process such a list based on a number of factors such as advertisements, discounts etc., based upon inventory items that are configured within the respective home appliances for replacement/replenishment, as described above and in more detail below.

The home shopping environment described herein may be performed in real time to allow prompt updates by appliances of inventory items that are out of stock or that are configured for replacement, and updates of consolidated shopping lists. For purposes of the present description, real time shall include any time frame of sufficiently short duration as to provide reasonable response time for information processing acceptable to a user of the subject matter described. Additionally, the term “real time” shall include what is commonly termed “near real time,” generally meaning any time frame of sufficiently short duration as to provide reasonable response time for on-demand information processing acceptable to a user of the subject matter described (e.g., within a portion of a second or within a few seconds). These terms, while difficult to precisely define, are well understood by those skilled in the art.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics for example are as follows and not limited to the following:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows and not limited to:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

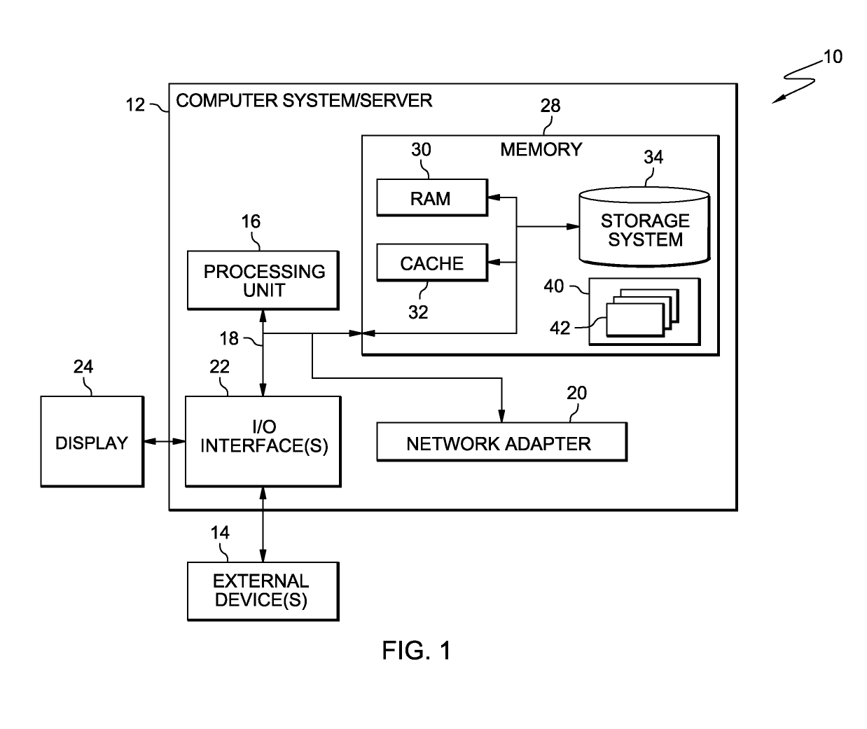

Reference is now made to FIG. 1, a schematic of an example of a cloud computing node, which may be a computer system, a desktop, laptop, any portable electronic device such as a PDA, mobile phone, etc., which may be interfaced with the smart home environment. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, computer-readable storage media system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein. Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

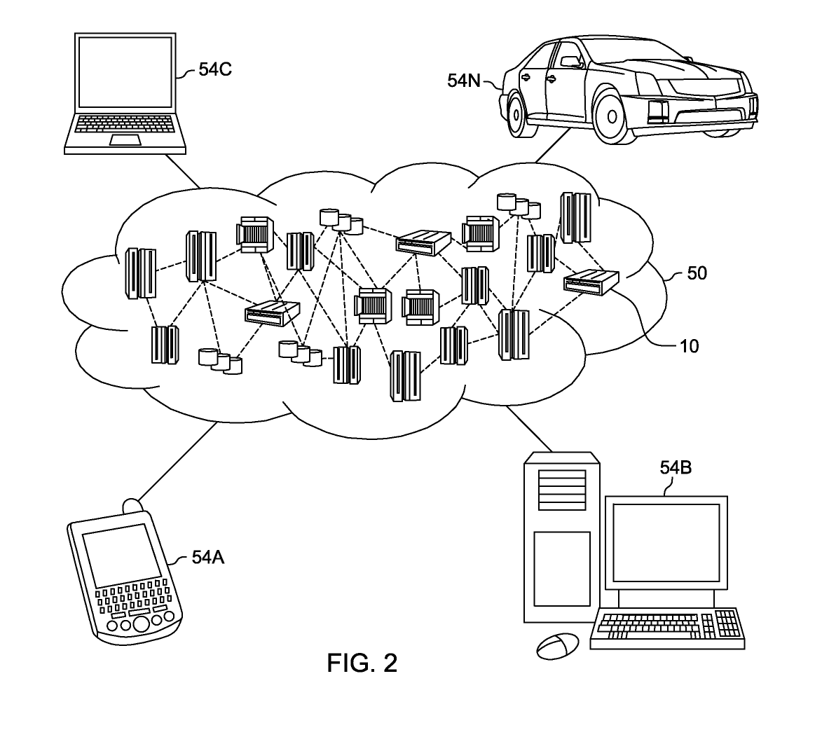

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

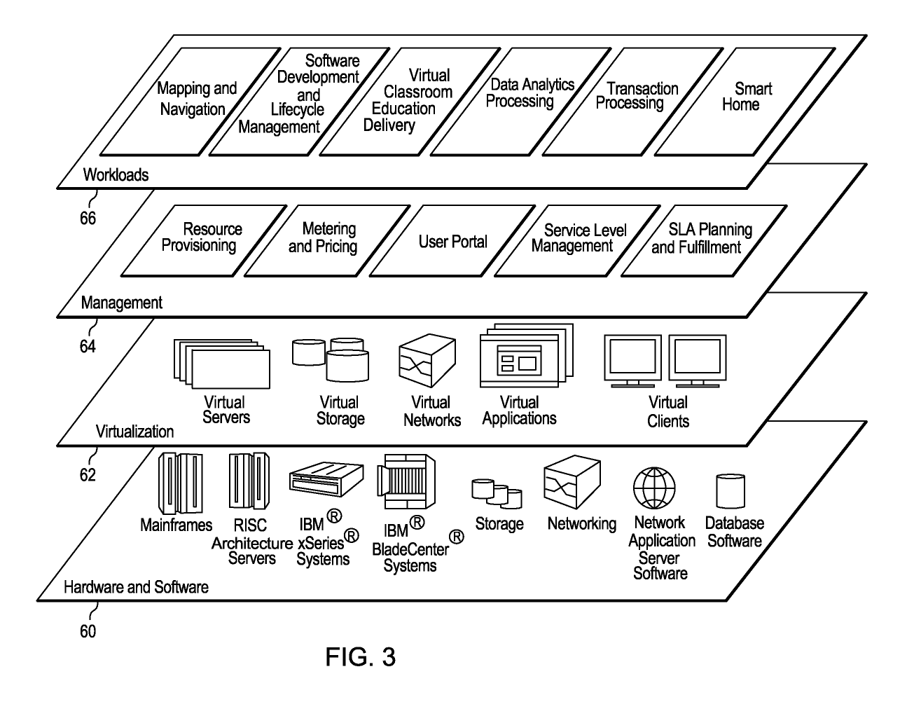

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing. In one embodiment the smart home environment may be part of the workload layer 66, in an exemplary manner and should not be restricted to, but may be part of other layers as well.

It is therefore proposed to have a list of extensions features and/or policies that can be applied to the entire deployed pattern or part of the deployed pattern, based on all or any combination of the following:

Metadata of the deployed pattern like type of VMs (web server, app server etc.), type of pattern (eg. CRM, ERP etc.), product details (eg. db vendor, version or web server vendor, version), static policies etc. Using heuristics and insights from the deployed pattern usage and Runtime policy extensions like Power Savings, HA, DR, load balancing etc. The list can be pre-populated with some initial choices based on using all or some combination of parameters disclosed above or can be updated or built on the fly using the parameters disclosed above.

The user can select the type of extension required and the same gets effectuated for the deployed pattern. Similarly the user can remove the extension usage once the requirements are fulfilled or can save the entire workload as a new pattern. It is also proposed that the existing chargeback model for the pattern will be updated to account for the extension.

As will be appreciated by one skilled in the art, embodiments of the present invention may be embodied as a system, method, or computer program product. Accordingly, aspects/embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects/embodiments of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

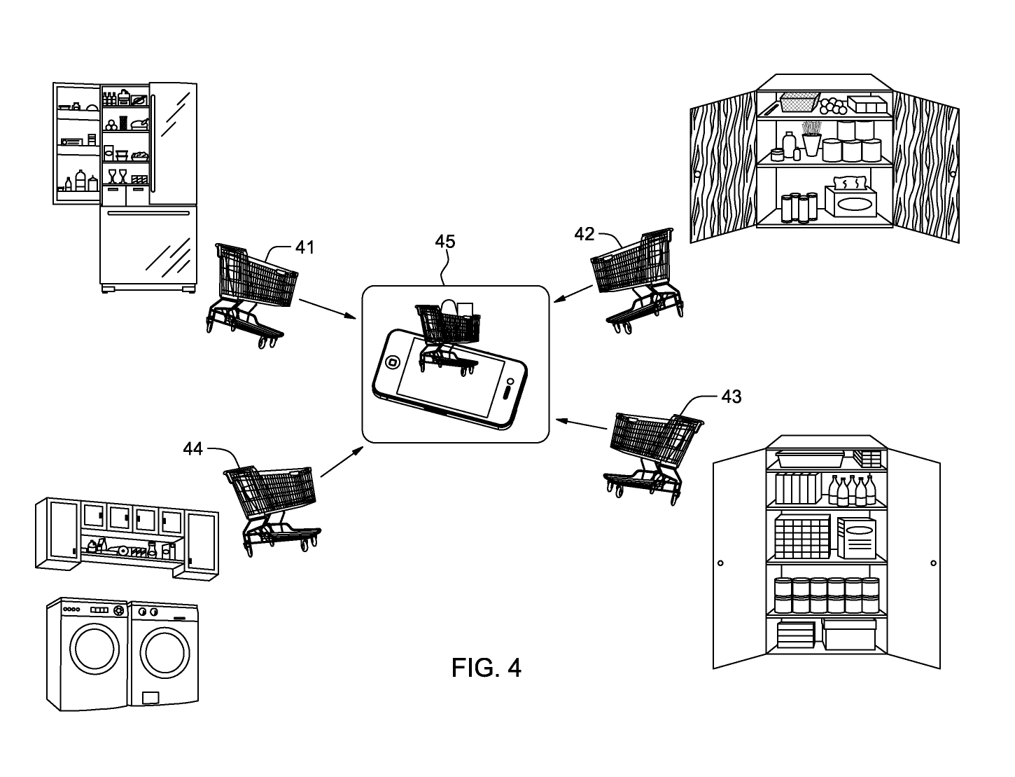

FIG. 4 is an illustrative embodiment of a smart home shopping environment. Currently there is a mismatch between what people/customers/users purchase and what is needed at home. People tend to purchase a lot of redundant items, which may be present at home, or they may miss the required items. This happens because human beings maintain shopping lists manually, without any intelligent inputs from the individual appliances as has been discussed previously. Proposed herein is a method for the smart-home environment including home appliances to build and maintain one or more shopping carts, based on the needs or specified requirements of the user, and consolidating a centralized shopping cart to a portable electronic device, available with the end-user.

Currently, shopping lists are created and maintained manually by the end-user without considering the requirements/needs of the appliances. However, the appliances are the storage units of the items and may be the best judges of their inventory levels. Thus, when the end-user actually goes shopping or wants to order an item, there could be a mismatch between what an appliance needs and what has actually gone on the shopping list. Humans, with current approaches, at best, maintain the inventory level of appliances at a sub-optimal level, and the present invention overcomes this by use of the smart home environment including a number of appliances.

This invention makes use of the needs of the user, as determined by a smart appliance, for populating a shopping cart. Many items, for a user who is shopping, are purchased by the user based on their need, and not the brand value that the item carries. For example, consider a user need for purchasing washing powder. Users don't always worry about the brand and would be satisfied if they get a more or less “decent” washing powder, the need being an item for washing clothes. Embodiments of the invention capture this need. When a smart home appliance needs an item, it transmits the “need” and not the item per se to a device, such as the mobile phone or a server, which can collect and consolidate such needs. Next this need is interpreted and whenever the user goes to the shopping mall or an online shopping site, the electronic portable device finds the various items, which would satisfy this need and alert the user. Then, depending upon the rule engine or a set of pre-defined rules that are present in the electronic portable device, which may have rules for minimum, maximum, and desired price, allowed brands, minimum and maximum quantity, flavors, retail outlet, etc., the shopping cart is updated and a ranked list is provided to the user who can then shop or order the item.

Appliances, which are part of the smart-home environment, are better managers of the shopping cart than a human being per se, and this is due to the fact that the exact inventory level at any given point of time may be known to the appliance. Thus, the appliance is able to provide the details on the required items that it needs at any given point of time to the electronic portable device. FIG. 4 is an illustration that depicts an embodiment of the proposed invention, where the individual appliances maintain their own shopping carts for the items they are responsible for.

In a preferred embodiment, each appliance in the smart-home has its own digital shopping cart, as depicted in FIG. 4, which it maintains to manage its inventory level. CRUD (Create, Read, Update, Delete) operations on these digital shopping carts can be programmatically adjusted to meet individual user needs. This way the user can specify his/her inventory requirements in the appliances. Alternatively, the digital shopping cart can also be implemented as an intelligent shopping cart to learn user requirements, based on, for example, past history, seasonal fluctuations, etc.

In FIG. 4 the following appliances maintain their own shopping carts. Perishable grocery goods stored in a refrigerator (Shopping Cart 41) [Category Type=Perishables]. Bathroom and toilet accessories in a bathroom cupboard (Shopping Cart 42) [Category Type=Toiletries]. Stationeries stored in a study-room cupboard ((Shopping Cart 43)) [Category Type=Stationery]. Detergents/Soaps/washing powder/etc. stored in a washroom cupboard (Shopping Cart 44) [Category Type=Detergent].

Whenever the inventory of any item in the appliance goes below the pre-configured or calculated Re-Order Level (ROL), the appliance places the item in its shopping cart. These individual shopping carts next synch their items to be purchased with the shopping cart maintained at the electronic portable device 45 (real-time synchronization mechanism). An alternative embodiment consists of batch-wise synchronization of the appliance shopping cart with the electronic portable device (push-based mechanism). Yet another embodiment consists of synchronization of the appliance shopping cart with the electronic portable device when it demands it (pull-based mechanism). After the shopping is completed and the commodities are stored in the respective appliances, the inventory data in the appliances are updated automatically with the quantity shopped.

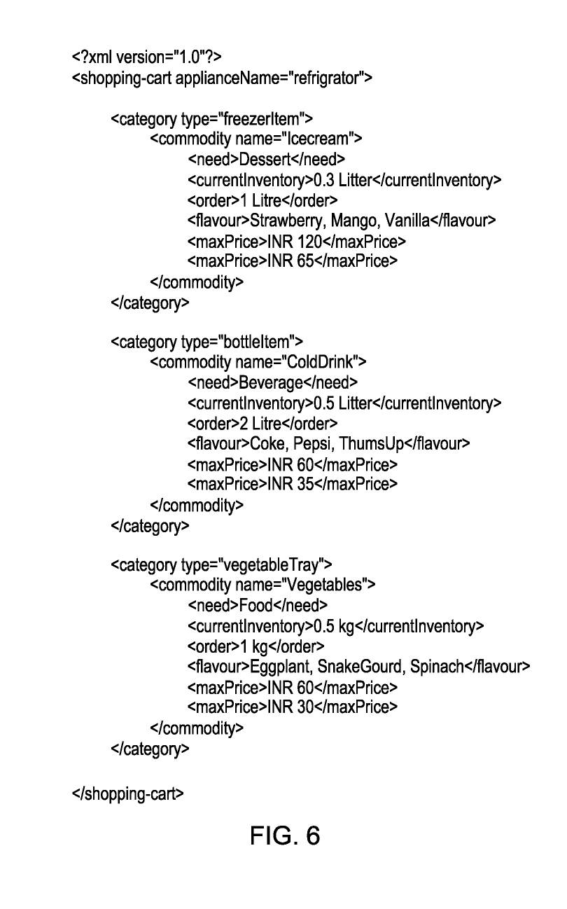

FIG. 6 depicts what a typical appliance shopping cart would look like, as implemented in XML code. Every appliance will have its own shopping cart, which would be sent to the electronic portable device.

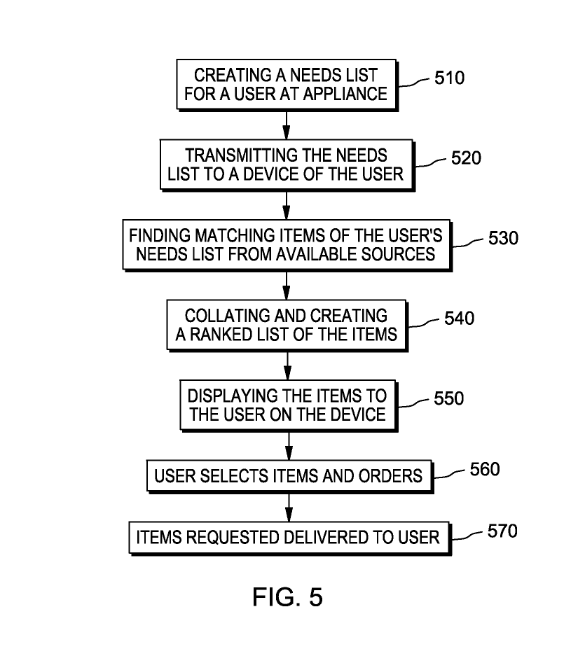

Reference is now made to FIG. 5, which illustrates an exemplary embodiment of a flow chart of the present invention. In step 510, the appliance determines the need of a user from the items that are available with such an appliance. For example, if the appliance is a refrigerator, the appliance can keep track of the amount of milk purchased by the user and the amount consumed. If there is a shortfall, the appliance determines a need for milk and creates a needs list, and transmits the list to a server or a portable electronic device which is capable of processing such a request. In another embodiment, the appliance can keep track of product expiration dates and create a needs list based on this parameter.

In step 520, when such a need is identified, the appliance consolidates all the needs into a needs list and transmits the needs list to a server, which can then consolidate all the lists from all appliances, and transmit the consolidated list to a portable electronic device, such as a mobile phone of the user. In an alternate embodiment, the appliances can transmit the needs list to the portable electronic device and the portable electronic device can consolidate the needs list into a single shopping or needs list, or consolidate the needs list category wise.

In step 530, the mobile device can transmit the needs list to applications on the cloud or network and find matching items from the available sources based on pre-defined rules, such as discounts, distance from the user's home, user feedback, etc. In step 540, the information returned from the applications on the cloud or network is collected and collated, and then presented to the user in the form of a ranked list of items, with the source where the item is available. In step 550, the ranked list is displayed to the user.

In step 560, the user selects the item and can order the item online. In step 570, the item is delivered to the user following a transaction (not shown) under a standard e-commerce or m-commerce transaction. In another embodiment, in step 560, the portable device is configured to identify items available at various sources depending on, for example, distance from the user's home, and accept inputs from the user on the items, if the user will be shopping for the items. In another embodiment, the portable device can be near field communication (NFC) enabled such that when the user is shopping in an NFC enabled store, when the item is detected, the user is alerted regarding availability of the item.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, by one or more processors, one or more inventory needs lists from one or more respective smart appliances; and
identifying, by the one or more processors, sources for available inventory items on the received inventory needs lists, based on pre-defined rules.

2. A method in accordance with claim 1, further comprising:
displaying, by the one or more processors, the available items to a user; and
receiving, by the one or more processors, one or more inputs indicating inventory items to purchase.

3. A method in accordance with claim 2, further comprising:
displaying, by the one or more processors, associated metadata for one or more of the available items, the metadata including one or more of: price, discounts, quality, brand, flavor, user reviews, and advertisements.

4. A method in accordance with claim 2, wherein displaying the available items further comprises:
displaying, by the one or more processors, the available items to a user in a ranked list based on one or more of: need, discount, and price.

5. A method in accordance with claim 1, further comprising:
determining, by the one or more processors, one or more travel routes connecting all identified sources of the available inventory items on the received inventory needs lists, the travel routes including one or more of:
an optimal travel route from and returning to a user's home,
an optimal travel route from a user's current location to a user's home,
an optimal travel route from a specified location to a user's home,
an optimal travel route from a user's home to a specified location, and
an optimal travel route from and returning to a specified location.

6. A method in accordance with claim 1, wherein the pre-defined rules identify sources for available inventory items on the received inventory needs lists based on one or more of: desired price, minimum price, maximum price, brand name, desired quantity, minimum quantity, maximum quantity, product flavor, retail outlet, available discounts, travel distance to source, travel time to source, and user reviews.
